(19) United States
(12) Patent Application Publication
(10) Pub. No.: US 2026/0289385 A1
(43) Pub. Date: Sep. 24, 2026

(54) DYNAMIC DIRECTED ACYCLIC GRAPH SCHEDULING USING ARTIFICIAL BEE COLONY OPTIMIZATION WITH ADAPTIVE REINFORCEMENT LEARNING AND ANOMALY DETECTION

(71) Applicant: Dell Products L.P., Round Rock, TX (US)

(72) Inventors: Gagan Deep Singh, Bengaluru (IN); Satyam Kumar, Bengaluru (IN); Saurabh Jha, Leander, TX (US)

(21) Appl. No.: 19/083,243

(22) Filed: Mar. 18, 2025

(51) Int. Cl. G06N 20/00; G06F 11/07

(52) U.S. Cl. CPC G06N 20/00; G06F 11/0751

(57) ABSTRACT

A method for managing a computing environment includes obtaining, by a test evaluation system, a request for scheduling a plurality of tasks executed in the computing environment, in response to the request: initializing a reinforcement learning agent using parameters based on an experience function, determining, by the reinforcement learning agent and based on a current state of the computing environment, a schedule adjustment action of the plurality of tasks using the experience function, applying the schedule adjustment action on a current task execution schedule of the plurality of tasks, monitoring, using an anomaly detection model, execution of the schedule adjustment action, wherein the anomaly detection model is optimized using an artificial bee colony (ABC) algorithm, and updating, based on the monitoring, the experience function and the current state.

### BACKGROUND

Scheduling tasks in a computing environment may be complex relative to the number of tasks executing in the computing environment. As the number of tasks to be scheduled increases, the complexity of scheduling such tasks may increase proportionately or exponentially. Further, workflow scheduling may include using directed acyclic graphs (DAGs) of the tasks.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention,

FIG. 2A shows a diagram of a relationship between states, actions, and rewards in accordance with one or more embodiments of the invention.

FIG. 2B shows a diagram of an experience function in accordance with one or more embodiments of the invention.

FIG. 3A shows a flowchart of a method for generating and deploying an anomaly detection model in accordance with one or more embodiments of the invention.

FIG. 3B shows a flowchart of a method for managing scheduling of tasks in a computing environment in accordance with one or more embodiments of the invention.

FIG. 4 shows an example diagram in accordance with one or more embodiments.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for scheduling workflows of multiple tasks to be executed in a computing environment. Embodiments of the invention include using an artificial bee colony (ABC) algorithm for optimizing an anomaly detection model that utilizes a decision tree classifier, a CatBoost classifier, and an Isolation Forest algorithm to detect anomalies in execution of a directed acyclic graph (DAG) of tasks. Further, embodiments of the invention apply reinforcement learning and leverage experience functions and the optimized anomaly detection to schedule an optimal DAG for a set of tasks to be executed. During execution of the scheduled DAG, embodiments of the invention include dynamic adjustment of the DAG in response to any detected anomalies, ensuring timely execution of tasks and preventing system overloads. The execution and dynamic adjustments may be stored in historical execution datasets that may be used for future optimization of the anomaly detection models (e.g., using the ABC algorithm) and future dynamic DAG scheduling.

In rapidly evolving data-driven environments, the ability to efficiently manage and schedule complex workflows may be considered a critical requirement for organizations across diverse industries. The complexity of orchestrating data-driven DAGs within scheduling frameworks may necessitate advanced optimization and learning methods to ensure that tasks are executed in a timely and resource-efficient manner. Existing systems may be often constrained by their reliance on static or heuristic-based scheduling approaches, which could lead to inefficiencies, particularly when handling dynamically changing data inputs, resource constraints, and execution anomalies. Embodiments of the invention may introduce a novel system and method for intelligent, dynamic DAG scheduling, which utilizes a hybrid approach that combines the ABC optimization algorithm, adaptive reinforcement learning and anomaly detection techniques. The system leverages these methods to improve scheduling accuracy and optimize task execution across multiple stages of the DAG. A potential objective may be to minimize execution delays, maximize resource utilization, and automatically adapt to changing system conditions, while outperforming traditional methods.

Embodiments of the invention may include the integration of the ABC optimization algorithm, which mimics the foraging behavior of honeybees, into the DAG scheduling process and into the anomaly detection model parameter optimization. The ABC algorithm operates in three distinct phases: employed bees, onlooker bees, and scout bees. Each phase is responsible for exploring and exploiting potential solutions to optimize the parameters being measured. In the employed bees phase, food sources (solutions) are evaluated and mutated to explore new potential schedules. The solutions may be implemented, for example, as weights for the anomaly detection model. The onlooker bees phase includes selecting the most promising schedules based on their fitness, refining them further. Finally, the scout bees phase introduces random mutations to escape local optima and discover new, unexplored solution opportunities.

To further enhance the optimization process, the system employing embodiments of the invention may incorporate a reinforcement learning (RL) agent that dynamically adjusts the DAG schedule based on feedback from the environment. The RL agent operates within a state-action-reward framework, where the state is determined by the current system conditions (e.g., task execution times, resource availability, etc.), and the actions involve advancing, delaying, or maintaining the schedule. The reward mechanism incentivizes the RL agent to choose actions that improve overall system performance, such as reducing execution delays or preventing resource bottlenecks. By continuously updating its Q-table (also referred to as an experience function table or an experience function), the RL agent learns from historical scheduling data and improves its decision-making over time. This adaptive learning process allows the system to handle both predictable and unpredictable changes in workload, ensuring that DAG execution remains optimal even in highly dynamic environments.

Embodiments of the invention may include an ability to detect anomalies in DAG execution. Anomalies may occur due to various reasons, such as unexpected task failures, resource exhaustion, or network latencies. Such anomalies may disrupt the execution of the DAG. To address this challenge, the system uses a multi-model anomaly detection approach that integrates decision trees, CatBoost classifier and isolation forest. The decision tree model provides an initial classification of execution anomalies based on historical data, which is further refined by the CatBoost classifier. Finally, the isolation forest model is applied to identify outliers and unusual patterns in execution metrics. The combination of these models enables the system to detect anomalies with high precision and accuracy. Once anomalies are detected, the ABC optimization algorithm may be applied to dynamically adjust the schedule, compensating for potential delays or disruptions. The ABC algorithm's flexibility may allow the system to re-optimize the schedule by redistributing tasks or adjusting resource allocations in real-time, ensuring that the DAG continues to execute efficiently.

The integration of anomaly detection with ABC optimization ensures that the system is resilient to execution failures and can recover from disruptions with minimal impact on overall performance. A key outcome of this intelligent scheduling system is its ability to achieve a scheduling accuracy of 90%, significantly surpassing the current state-of-the-art accuracy of 80%. This improvement may be attributed to the synergistic interaction between the ABC optimization algorithm, reinforcement learning and anomaly detection. The system may continuously learn and adapt to new execution data, refining its scheduling decisions based on both historical patterns and real-time feedback. Moreover, the use of ABC optimization allows for exploration of a larger solution space, leading to more efficient schedules that better align with real-world constraints and objectives. This invention represents a significant advancement in the field of dynamic workflow orchestration and has broad applications across industries that rely on complex DAGs for data processing, machine learning pipelines, and ETL (Extract, Transform, Load) tasks. By leveraging the power of bio-inspired optimization algorithms and adaptive learning, the system provides a robust, scalable solution for managing the increasing complexity of modern data-driven workflows. Furthermore, the anomaly detection and correction mechanisms ensure that the system is capable of handling unexpected execution challenges, making it an ideal choice for mission-critical applications where reliability and performance are paramount.

The invention presents a comprehensive, intelligent DAG scheduling system that combines Artificial Bee Colony optimization with reinforcement learning and anomaly detection to deliver superior scheduling accuracy and adaptability. The ability to dynamically adjust to changing system conditions and optimize resource utilization in real-time sets this system apart from traditional scheduling methods, making it a valuable tool for organizations seeking to streamline their data workflows and improve operational efficiency. The achievement of 90% scheduling accuracy marks a significant milestone in the evolution of workflow management systems, offering a clear advantage over existing approaches that typically reach 80% or less accuracy.

Various embodiments of the invention are described below.

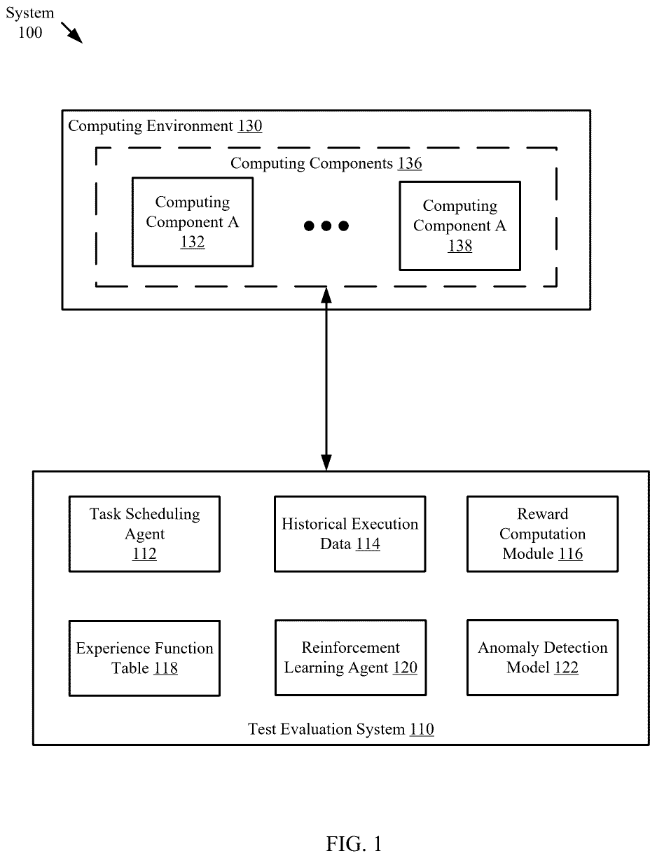

FIG. 1 shows a diagram of a system in accordance with one or more embodiments of the invention. The system (100) includes a computing environment (130) and a test evaluation system (110). The system (100) of FIG. 1 may include additional, different, and/or different components without departing from the invention.

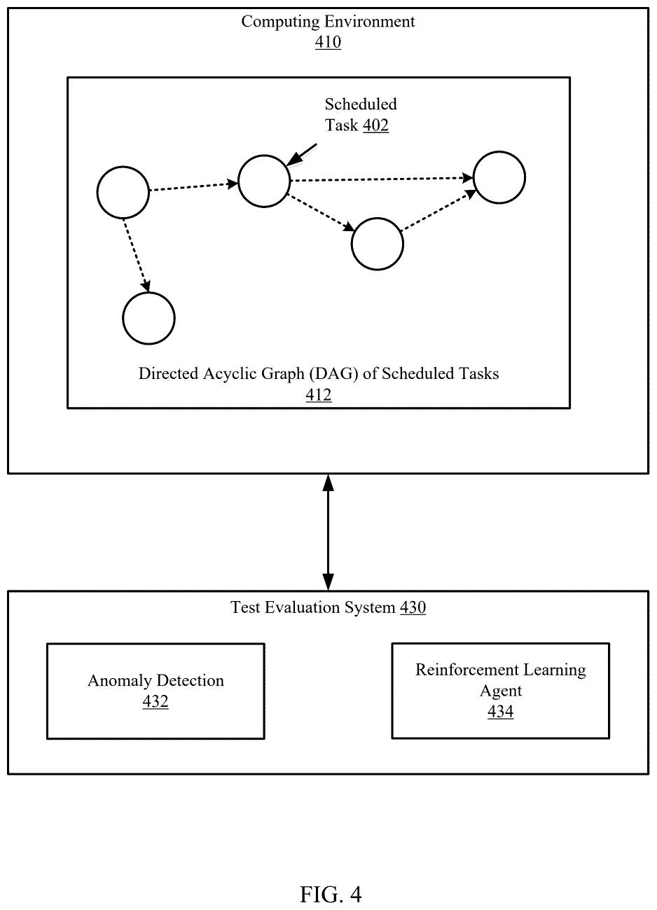

In one or more embodiments, the computing environment (130) includes functionality for providing computing services to users (not shown) or other entities. The computing environment (130) may be implemented as an environment of computing devices (see, e.g., FIG. 4). The computing devices may utilize any number of computing components (132, 138).

In one or more embodiments, at least a portion of the computing components (132, 138) of the computing environment (130) undergo operational testing. The computing components (136) may undergo operational testing as implemented by the automation job system (150) and the test evaluation system (110). For example, the computing components (136) may be implemented as a collection of servers, computers, storage devices, data centers, and/or other computing components without departing from the invention.

In one or more embodiments, the computing components (132, 138) each include functionality for executing tasks. The tasks may be scheduled by the test evaluation system (110). In one or more embodiments, the tasks may include, for example, any data processing tasks, tasks for machine learning pipelines, and tasks for ETL. The tasks may include dependencies to other tasks, and as such, may be required to be executed in an order relative to the other tasks. To manage the execution of tasks in an optimal order, a directed acyclic graph (DAG) may be generated that specifies an ordering and/or a schedule for executing a set of tasks. The DAG may be generated by, for example, the task scheduling agent (112) of the test evaluation system (110).

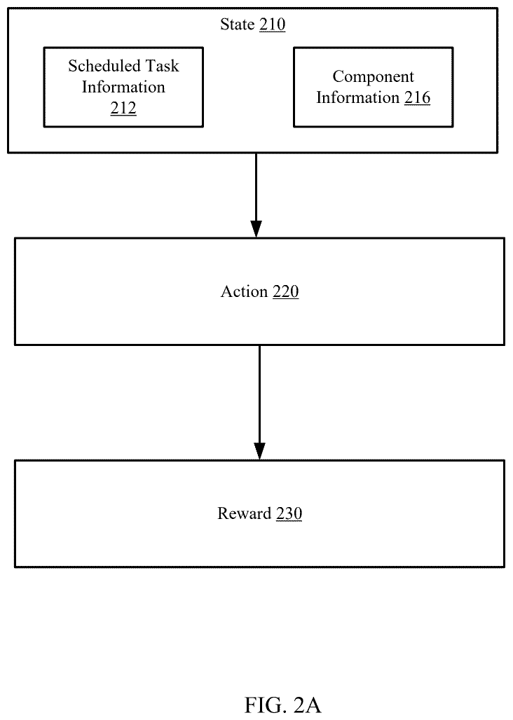

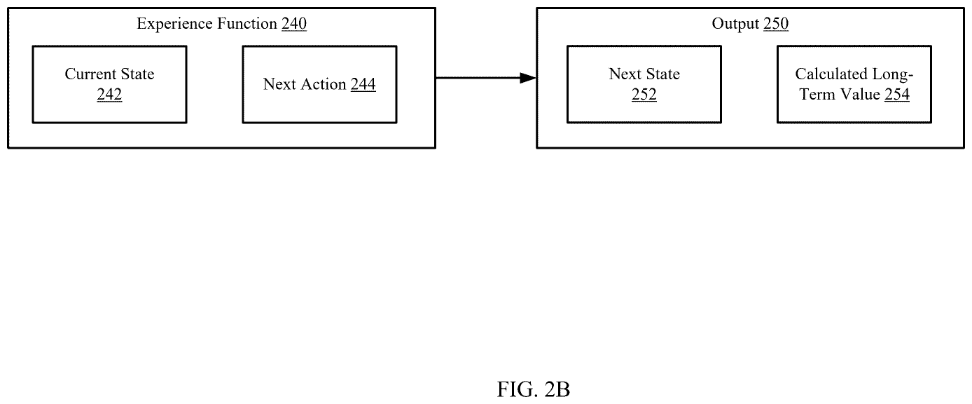

The generation of a DAG may be based on parameters of the computing environment (130), parameters of the individual computing components (136), and/or parameters of the tasks. The parameters of the individual components may include, for example, computing resource availability of the computing resources (136), a list of computing components (136) capable of servicing each task in a set of tasks, and/or existing task execution schedules for each computing component. Parameters of the tasks may include, for example, dependency information of each task, computing resource requirement for each task, and/or time requirements of the tasks. Other parameters may be used to describe the parameters of the individual components, the computing environment (130), and/or the tasks without departing from the invention. The parameters of the computing components and the parameters of the tasks at a point in time may be collectively referred to as a state of the computing environment (130). An example state may be described in, for example, FIG. 2A.

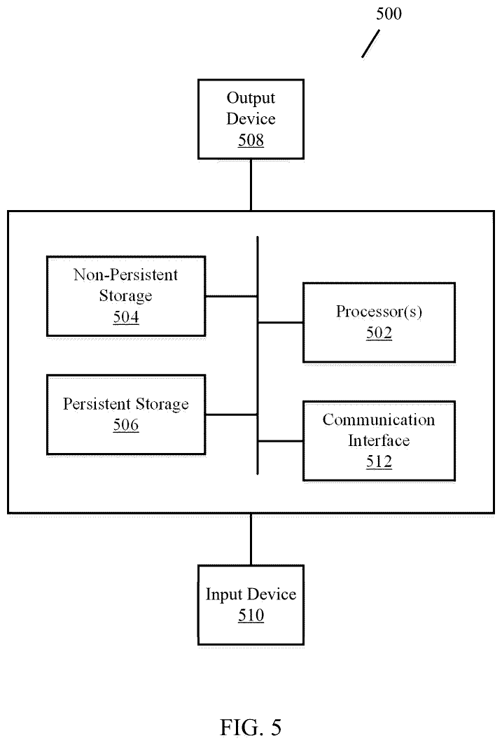

In one or more embodiments, the computing environment (130) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the computing environment (130) described throughout this application.

In one or more embodiments disclosed herein, the computing environment (130) is implemented as a logical device. The logical device may utilize the computing resources of any number of computing devices and thereby provide the functionality of the computing environment (130) described throughout this application.

In one or more embodiments, the test evaluation system (110) may include functionality for generating schedules for tasks to be executed in the computing environment (130). To perform the aforementioned functionality, the test evaluation system (110) includes a task scheduling agent (112), historical execution data (114), a reward computation module (116), an experience function table (118), a reinforcement learning agent (120), and an anomaly detection model (122). The test evaluation system (110) may include additional, fewer, and/or different components without departing from the invention.

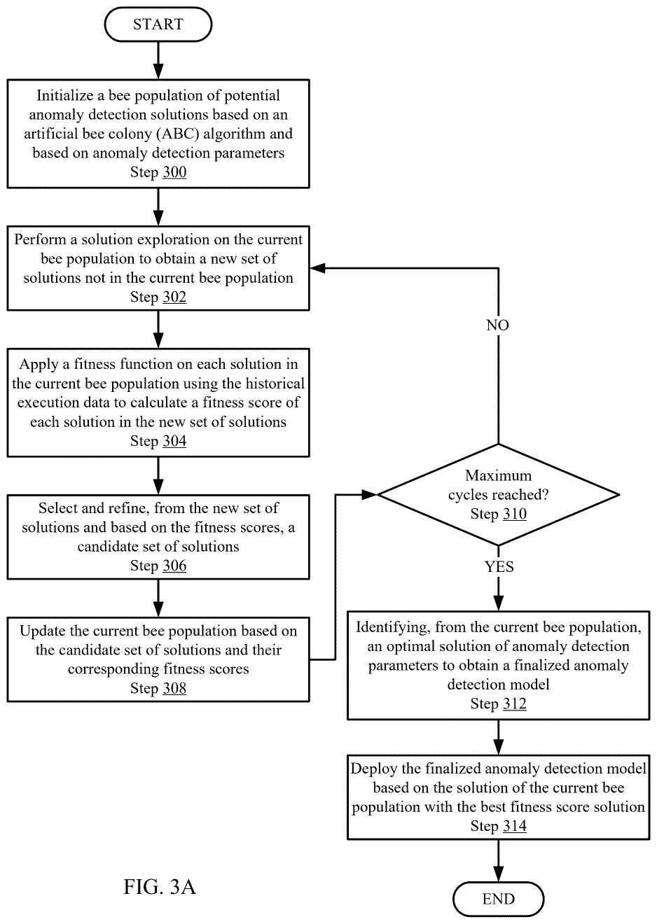

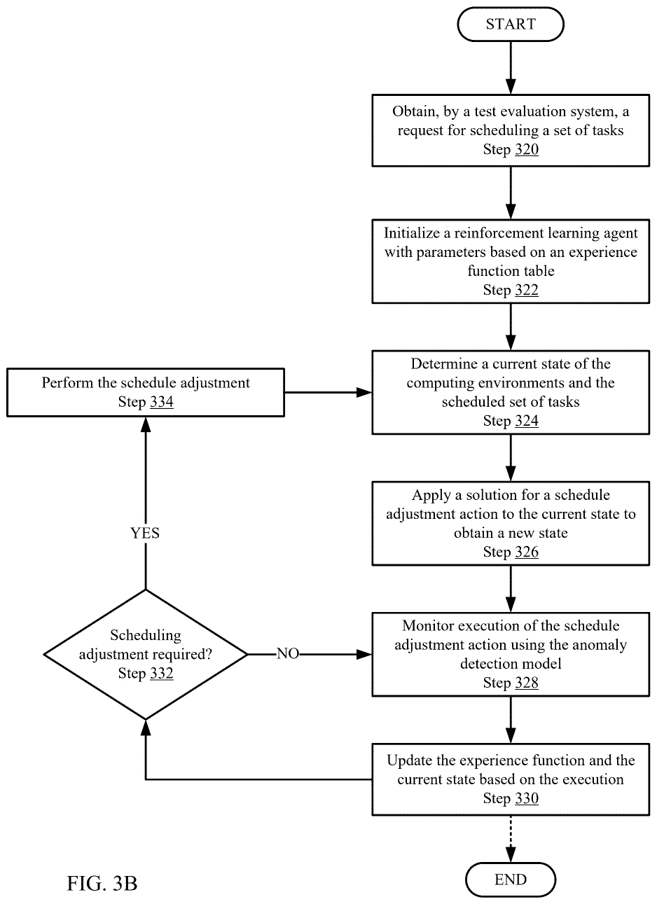

In one or more embodiments, the task scheduling agent (112) includes functionality for scheduling tasks to be executed in the computing environment (130). The task scheduling agent (112) may perform, for example, the method of FIG. 3B to perform the task scheduling. Other methods may be performed without departing from the invention.

In one or more embodiments, the historical execution data (114) is a data structure that stores the historical information of previous executions of tasks and/or previous states of the computing environment (130). The historical execution data (114) may include, for example, resource consumption of the computing components (136), state information of the computing environment (130) and/or of a set of tasks, and/or any other information.

In one or more embodiments, the reward computation module (116) includes functionality for computing a reward for a selected action (described in FIG. 2A) based on monitoring of the execution of a set of tasks in accordance with a DAG. The reward may be tracked based on the result of applying the selected action for the given state.

In one or more embodiments, the reinforcement learning agent (120) includes functionality for determining a next action based on historical rewards and/or long-term values. The long-term value may be calculated using a reinforcement learning algorithm. The experience function table (118) may be updated based on, for example, the current state, an action (“a”), a reward for implementing the action to the current state, and a next state resulting from applying the action. Examples of reinforcement learning algorithms used for updating the experience function include, but are not limited to: a Q-learning algorithm, deep Q network (DQN) algorithm, and a double deep Q network (DDQN) algorithm. For additional details regarding calculating the reward, refer to FIG. 2B. In one or more embodiments, the experience function table (118) may include a mapping between a current state (“s”), an action (“a”), and a reward and next state. The experience Q(s, a) is a mapping between a pair of states and actions to a maximum long term reward. For additional details regarding the experience function, refer to FIG. 2B.

In one or more embodiments, the anomaly detection model (122) is a data structure that obtains, as input, a state of the computing environment and/or historical execution data (114) for a given point in time, and outputs a determination about whether any parameters are anomalous. For example, sudden boosts in computing resources for a given execution of tasks, any bottlenecks of tasks caused by one of the computing components (132, 134), and/or any other anomalous parameters compared to other historical execution data (114) may be identified without departing from the invention. In one or more embodiments, the anomaly detection model (122) is generated in accordance with the method of FIG. 3A.

In one or more embodiments, the test evaluation system (110) (and/or any component illustrated within) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the test evaluation system (110) described throughout this application.

In one or more embodiments disclosed herein, the test evaluation system (110) is implemented as a logical device. The logical device may utilize the computing resources of any number of computing devices and thereby provide the functionality of the test evaluation system (110) described throughout this application.

FIG. 2A shows a diagram of a relationship between a state, action, and reward in accordance with one or more embodiments of the invention. As discussed above, a state (210) may be associated with a computing environment and/or a scheduled set of tasks at a given point in time. The state (210) may include, for example, scheduled task information (212) and component information (216). The state (210) of a test case may include additional, fewer, and/or different information without departing from the invention.

In one or more embodiments, the scheduled task information (214) relates to parameters of the set of tasks being executed. In one or more embodiments, the component information (216) relates to information about parameters of the computing components executing a given set of tasks. Examples of component information may include, for example, hardware information, operating system information, firmware information, performance status, capacity usage status, a rounding value of average total input/output operations (IOPS), average CPU utilization, average latency, and average physical space usage during the execution of the set of tasks.

In one or more embodiments, the test evaluation system (110, FIG. 1) discussed above observes the current state (210) at a point in time and may take an action (220) that specifies advancing (or modifying) the schedule of tasks (e.g., a DAG), maintaining the schedule of tasks, or delaying the execution of tasks (e.g., due to an anomaly detection).

In one or more embodiments, the result of applying the action (220) to the current state (210) may be used to calculate a reward (230). The reward (230) may represent a value relating to how much the action (220) leads to achieving the goal of a successful execution of the set of tasks.

For example, a reward for advancing the schedule may be calculated based on a difference between a reward for the advancing on the current state and the resource contention (or cost) for advancing the schedule. As such, the reward

FIG. 2B shows a diagram of an experience function in accordance with one or more embodiments of the invention. As discussed above, the experience function (240) is an embodiment of the experience function table (118, FIG. 1) discussed above. The experience function (240) may generate an output (250) based on an input that includes a current state (242), an action (also referred to as a next action) (244). The output (250) may include a next state (252) and a calculated long-term value (254). The next state (252) may represent an expected state resulting from applying the changes associated with the next action (244) to the current state (242).

The calculated long-term value (254) represents a maximum expected value that selecting the next action (244) to be performed on the current state (242) based on a cumulative reward of future actions applied to the next state (252). For example, a high calculated long-term value (254) of a given input of the experience function (240) may relate to a high expected reward of applying the next action (244) for learning about future actions that result in future expected rewards.

FIG. 3A shows a flowchart of a method for generating and deploying an anomaly detection model in accordance with one or more embodiments of the invention. The method shown in FIG. 3A may be performed by, for example, a test evaluation system (110, FIG. 1). Other components of the system illustrated in FIG. 1 may perform the method of FIG. 3A without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 3A, in step 300, a bee population of potential anomaly detection solutions are initialized based on an artificial bee colony (ABC) algorithm and based on anomaly detection parameters. In one or more embodiments, the anomaly detection parameters are each associated with a weight applied to one of three machine learning classifiers: a decision tree classifier, a CatBoost classifier, and an isolation forest classifier. Each combination of weight values may correspond to a solution in the bee population (also referred to as a population). The initial bee population may be a randomized set of solutions (e.g., weights for the machine learning classifiers). The weights may be optimized by minimizing an error in anomaly classification of a given training set of historical data. The historical data may specify, for example, execution duration, resource usage (e.g., memory, persistent storage, processing, etc.), and any other performance-based metrics during execution of a set of tasks.

An example solution of a bee population may include, for example, weights w1, w2, and w3. An example anomaly detection model may include, for example, a function described as: w1*DT(x)+w2*CB(x)+w3*IF(x), where DT(x) represents an output of applying a data point x to the decision tree classification, CB(x) represents an output of applying a data point x to the CatBoost classification, and IF(x) represents an output of applying a data point x to the isolation forest classification. Each solution in the bee population may be a unique combination of values for w1, w2, and w3. The training of each of the classification models (e.g., DT(x), CB(x), and IF(x)) may be performed independently from the anomaly detection model generation described throughout the method of FIG. 3A.

While the method of FIG. 3A describes the anomaly detection model as including three classification models (i.e., DT(x), CB(x), and IF(x)), additional, fewer, and/or different classification models may be used to represent an anomaly detection model in accordance with one or more embodiments of the invention.

In step 302, a solution exploration is performed on a current bee population to obtain a new set of solutions. In one or more embodiments, the solution exploration includes perturbing, for each solution, one or more of the weights to obtain new combinations of weights with one or more modifications from an existing solution in the bee population.

In step 304, a fitness function is applied to each solution in the current bee population using historical execution data and based on training of anomaly detection to calculate a fitness score of each solution in the new set of solutions. In one or more embodiments, the fitness score of a solution is a calculation representing an accuracy of applying the historical dataset to the given solution.

In one or more embodiments, the fitness score is calculated by aggregating, for each data point in the historical data, a difference between a calculated anomaly score (based on an anomaly detection model with the corresponding weights) of the data point and a true anomaly score of the data point. In such embodiments, a higher fitness score value represents a high inaccuracy for a solution to detect anomalies in the historical data.

In one or more embodiments, while the fitness function is described as being applied to each of the new set of solutions in step 304, the fitness function may be applied to each solution in the initial bee population of step 300 prior to the solution exploration of step 302. In this manner, all solutions in the bee population and in the new set of solutions are calculated with a corresponding fitness score.

In step 306, a candidate set of solutions are selected and refined from the new set of solutions. In one or more embodiments, the candidate set of solutions are selected based on the fitness scores. For example, such solutions in the new set of solutions with the fitness scores corresponding to the most accurate anomaly scores may be selected for the candidate set of solutions. Additional refining may be applied to the selected solutions by, for example, applying modifications to the weights to obtain refined solutions. The refined (or unrefined) solutions selected from the new set of solutions based on their fitness scores may be deemed the candidate set of solutions.

In step 308, the current bee population is updated based on the candidate set of solutions. In one or more embodiments, the bee population is updated by populating the current bee population with the candidate set of solutions. In this manner, the bee population includes additional solutions that may be evaluated in subsequent iterations of steps 302-308.

In step 310, a determination is made about whether a maximum number of cycles is reached. In one or more embodiments, the maximum number of cycles is a pre-defined value that specifies a maximum number of iterations of steps 302-308 to be performed to update the bee population. If the maximum number of cycles is reached, the method proceeds to step 312; otherwise, the method returns to step 302 with the updated bee population generated in step 308 representing the current bee population described throughout the next iteration of steps 302-308.

In step 312, following the determination that the number of maximum cycles is reached, an optimal solution of anomaly detection parameters (e.g., the weights) is identified to obtain a finalized anomaly detection model. In one or more embodiments, the optimal solution is such solution from the current bee population that represents the best fitness score (e.g., the lowest inaccuracy). The finalized anomaly detection model includes the combination of weights represented by the optimal solution and the use of the corresponding classification models.

In step 314, the finalized anomaly detection model is deployed based on the optimal solution. The deployment of the finalized anomaly detection model may result in anomaly detections calculated on future execution data. For example, the method of FIG. 3B may include monitoring the computing environment based on the finalized anomaly detection model.

FIG. 3B shows a flowchart of a method for managing scheduling of tasks in a computing environment in accordance with one or more embodiments of the invention. The method shown in FIG. 3B may be performed by, for example, a test evaluation system (110, FIG. 1). Other components of the system illustrated in FIG. 1 may perform the method of FIG. 3B without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 3B, in step 320, a request for scheduling of a set of tasks is obtained. The request may specify the set of tasks, dependency information of each task, computing resource requirements of each task, and/or any other information without departing from the invention.

In step 322, a reinforcement learning agent is initialized with parameters. The parameters may include, for example, parameters of the tasks, parameters of the computing environment, and parameters of the computing components. Other parameters may be used to initialize the reinforcement learning agent without departing from the invention.

In step 324, a current state of the computing environment is determined. In one or more embodiments, the current state is determined by obtaining information about the current performance metrics and resource usage information of the computing components in the computing environment and identifying the parameters of the tasks obtained from the request in step 320. For example, if tasks are currently executing in the computing environment, the resource use of the computing components to execute the tasks may be tracked as part of the state of the computing environment.

In step 326, a solution for a schedule adjustment action is applied to the current state to obtain a new state. In one or more embodiments, the schedule adjustment action may include maintaining a selected schedule of tasks (e.g., a generated DAG), advancing the selected DAG to obtain a new DAG, or delaying execution of the DAG (e.g., in response to a detected anomaly in the computing environment such as, for example, a larger than expected latency in task execution.

In one or more embodiments, the DAG is selected based on applying the ABC algorithm (similar to that discussed in FIG. 3A) to solutions that each represent a schedule of tasks. For example, any number of iterations of solution exploration, fitness function application, solution selection and refining, and bee population updating may be performed for solutions that each represent a schedule of tasks. An optimal solution may be identified based on a best calculated fitness score. The process of advancing the selected DAG to obtain the new DAG may include re-applying the ABC algorithm on a new population of solutions for scheduled tasks to obtain a new optimal DAG. The result of applying the schedule adjustment action is an updated state of the computing environment.

In one or more embodiments, the schedule adjustment action is determined based on a reinforcement learning agent identifying an optimal action. The optimal action is identified using an experience function that calculates, for each action and state pair, a long-term value. The pair of state and action that maps to the highest calculated long-term value is identified, and the corresponding action is selected as the optimal action.

In step 328, execution of the schedule adjustment action is monitored using the anomaly detection model. In one or more embodiments, the monitoring includes obtaining execution data such as performance metrics of the computing environment and applying the execution data to the anomaly detection model to identify an anomaly (if any) in the execution. Examples of anomalies include but are not limited to: significantly high latency in task execution, significantly high resource consumption by computing components in executing tasks, significantly high failure in task executions, and significantly poor performance. Data may be deemed significantly high based on comparisons to historical data as trained by the classification models of the anomaly detection model and the based on the corresponding weights.

In step 330, the experience function and the current state is updated based on the execution of the scheduled tasks. The experience function may be updated using a reward of applying the action (i.e., the schedule adjustment action) for the given state. The long-term value of the state-action pair is updated based on the result of the execution.

In such embodiments in which the execution of tasks is not complete at this point in time, the method proceeds to step 332; otherwise, the method may end after all tasks in the set of tasks have been executed, or whenever a failure notification of inability to execute the tasks is obtained.

In step 332, a determination is made about whether the scheduling adjustment is required. The scheduling adjustment may include advancing the schedule of tasks to generate a new schedule using the ABC algorithm. The determination for a scheduling adjustment may be based on whether an anomaly was detected in step 328 that requires a new schedule to be determined. If a schedule adjustment is required, the method proceeds to step 334; otherwise, the method proceeds to step 328.

In step 334, a schedule adjustment is performed. The schedule adjustment may be performed by identifying a new optimal solution based on applying the ABC algorithm to a population of potential solutions for the schedule of tasks.

### EXAMPLE

To clarify aspects of the invention, the following describes an example in accordance with one or more embodiments of the invention. The example is illustrated in FIG. 4. Turning to the example, consider a scenario in which a computing environment is to execute a set of tasks for a machine learning pipeline.

Turning to FIG. 4, a computing environment (410) includes any number of computing components such as servers, computing devices, logical devices, data structures, and/or other computing components (not shown) that enable the computing environment (410) to execute the set of tasks. The scheduling of the set of tasks may be represented using a DAG of the scheduled tasks (412). The DAG of the scheduled tasks (412) (also referred to simply as the DAG) may represent each scheduled task (e.g., 402) and their corresponding dependencies to other tasks. Further, the DAG (412) may indicate an ordering of the tasks, a dependency of each task to other tasks for execution, and/or other information for how the tasks are to be scheduled for execution.

To generate the DAG (412), a test evaluation system (430) performs the method of FIG. 3B. Specifically, the test evaluation system (430) uses a reinforcement learning agent (434) to analyze the state of the computing environment (410) that specifies the available computing components and other state information about the computing resources for each computing component. The state may further specify parameters of the set of tasks to be scheduled, which may include computing resource requirements, dependency information, and/or other parameters discussed throughout the present disclosure. The reinforcement learning agent (434) may utilize information obtained from previous deployments and schedules to generate the DAG (412) using the state and based on state-action rewards. The execution of the schedule of tasks may be monitored by the test evaluation system (410) based on an anomaly detection model (432). The anomaly detection model (432) may be generated in accordance with the method of FIG. 3A. The anomaly detection model (432) indicates, during execution, whether any anomalies are detected. The anomalies may be used to perform adjustments to the schedule, such as whether to reschedule the tasks, delay execution of one or more tasks, or continue with the execution of the tasks in accordance with the current DAG (412).

For example, the reinforcement learning agent (434) may explore the state-action space by determining whether to apply a random action or to apply currently-known optimal decisions for an action using an exploration and exploitation tradeoff (EET) value. The EET value may be a numerical value representing a percentage chance of selecting a random action over the known optimal decision. The EET value may vary each time a decision for applying a given action is made. For example, the EET value may decrease after each decision, as the chance increases each iteration that a known optimal decision is the universal best decision for a given state-action. Said another way, the benefit to exploring the action space (e.g., performing a random action) decreases in likelihood.

In such cases in which a rescheduling is to be performed, the ABC algorithm may be implemented on solutions for scheduling the tasks to obtain an optimized solution. The optimized solution may be implemented to obtain a new DAG (412), and the set of tasks may be scheduled in accordance with the new DAG (412).

The test evaluation system (410) may further update an experience function (not shown) that specifies long term values for performing given actions (e.g., rescheduling, continuing, or delaying) of scheduled tasks. Based on the results of performing the actions, rewards may be assigned to each pair of states and actions, and the experience function may be updated accordingly.

### End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computer (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention provide robust multi-component coverage of a computing environment to provide optimal scheduling of computing tasks in the computing environment. In a use case in which a large (e.g., thousands or millions) set of tasks are to be executed, a large number of parameters may be considered to determine how to schedule the execution of the set of tasks. Embodiments of the invention enable administrators of the computing environment to schedule the execution of tasks by considering the hyperparameter optimization of the state of the computing environment and the computational requirements of the tasks. Embodiments of the invention include the use of biology-inspired algorithms such as the ABC algorithm to optimize the scheduling of the tasks and the optimization of anomaly detection models used to monitor the execution. Embodiments of the invention incorporate these optimizations with reinforcement learning to optimize action selection of the scheduling adjustments.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing tasks in a computing environment, the method comprising:
obtaining, by a test evaluation system, a request for scheduling a plurality of tasks executed in the computing environment;
in response to the request:
initializing a reinforcement learning agent using parameters based on an experience function;
determining, by the reinforcement learning agent and based on a current state of the computing environment, a schedule adjustment action of the plurality of tasks using the experience function;
applying the schedule adjustment action on a current task execution schedule of the plurality of tasks;
monitoring, using an anomaly detection model, execution of the schedule adjustment action, wherein the anomaly detection model is optimized using an artificial bee colony (ABC) algorithm; and
updating, based on the monitoring, the experience function and the current state.

2. The method of claim 1, further comprising:
prior to the monitoring:
initializing a population of potential anomaly detection solutions based on anomaly detection parameters;
performing a solution exploration on the population to obtain a new set of solutions;
calculating a fitness score for each solution of the new set of solutions and for each potential anomaly detection solution of the population;
selecting, from the new set of solutions, a candidate set of solutions based on the fitness score of each solution of the new set of solutions;
appending the candidate set of solutions to the population to obtain an updated population;
identifying, from the updated population, an optimal solution based on a fitness score of each solution of the updated population; and
deploying the anomaly detection model using the optimal solution.

3. The method of claim 2, wherein the optimal solution comprises weights each associated with one of a list consisting of: a CatBoost classifier, a decision tree classifier, and an isolation forest classifier.

4. The method of claim 1, further comprising:
after monitoring the execution, detecting an anomaly in the execution;
based on the anomaly, applying a scheduling adjustment on the plurality of tasks; and
updating the current state based on the anomaly.

5. The method of claim 4, further comprising:
updating the anomaly detection model using the ABC algorithm in response to detecting the anomaly.

6. The method of claim 1, wherein the current task execution schedule is represented using a directed acyclic graph (DAG).

7. The method of claim 1, wherein the scheduling adjustment action comprises at least one of: delaying the current task execution schedule, adjusting the current task execution schedule to generate a new task execution schedule, or maintaining the current task execution schedule.

8. The method of claim 7, wherein the new task execution schedule is generated based on the ABC algorithm applied to scheduling parameters.

9. The method of claim 1, wherein the experience function is updated based on a reward associated with the schedule adjustment action, wherein the reward is determined based on the monitoring.

10. A non-transitory computer readable medium comprising computer readable program code, which when executed by a computer processor enables the computer processor to perform a method for managing tasks in a computing environment, the method comprising:
obtaining, by a test evaluation system, a request for scheduling a plurality of tasks executed in the computing environment;
in response to the request:
initializing a reinforcement learning agent using parameters based on an experience function;
determining, by the reinforcement learning agent and based on a current state of the computing environment, a schedule adjustment action of the plurality of tasks using the experience function;
applying the schedule adjustment action on a current task execution schedule of the plurality of tasks;
monitoring, using an anomaly detection model, execution of the schedule adjustment action, wherein the anomaly detection model is optimized using an artificial bee colony (ABC) algorithm; and
updating, based on the monitoring, the experience function and the current state.

11. The non-transitory computer readable medium of claim 10, the method further comprising:
prior to the monitoring:
initializing a population of potential anomaly detection solutions based on anomaly detection parameters;
performing a solution exploration on the population to obtain a new set of solutions;
calculating a fitness score for each solution of the new set of solutions and for each potential anomaly detection solution of the population;
selecting, from the new set of solutions, a candidate set of solutions based on the fitness score of each solution of the new set of solutions;
appending the candidate set of solutions to the population to obtain an updated population;
identifying, from the updated population, an optimal solution based on a fitness score of each solution of the updated population; and
deploying the anomaly detection model using the optimal solution.

12. The non-transitory computer readable medium of claim 11, wherein the optimal solution comprises weights each associated with one of a list consisting of: a CatBoost classifier, a decision tree classifier, and an isolation forest classifier.

13. The non-transitory computer readable medium of claim 10, the method further comprising:
after monitoring the execution, detecting an anomaly in the execution;
based on the anomaly, applying a scheduling adjustment on the plurality of tasks; and
updating the current state based on the anomaly.

14. The non-transitory computer readable medium of claim 13, further comprising:
updating the anomaly detection model using the ABC algorithm in response to detecting the anomaly.

15. The non-transitory computer readable medium of claim 10, wherein the current task execution schedule is represented using a directed acyclic graph (DAG).

16. The non-transitory computer readable medium of claim 10, wherein the scheduling adjustment action comprises at least one of: delaying the current task execution schedule, adjusting the current task execution schedule to generate a new task execution schedule, or maintaining the current task execution schedule.

17. The non-transitory computer readable medium of claim 16, wherein the new task execution schedule is generated based on the ABC algorithm applied to scheduling parameters.

18. The non-transitory computer readable medium of claim 10, wherein the experience function is updated based on a reward associated with the schedule adjustment action, wherein the reward is determined based on the monitoring.

19. A system, comprising:
a test evaluation operating on a processor; and
memory comprising instructions, which when executed by the processor, perform a method comprising:
obtaining, by a test evaluation system, a request for scheduling a plurality of tasks executed in a computing environment;
in response to the request:
initializing a reinforcement learning agent using parameters based on an experience function;
determining, by the reinforcement learning agent and based on a current state of the computing environment, a schedule adjustment action of the plurality of tasks using the experience function;
applying the schedule adjustment action on a current task execution schedule of the plurality of tasks, wherein the current task execution schedule is represented using a directed acyclic graph (DAG);
monitoring, using an anomaly detection model, execution of the schedule adjustment action, wherein the anomaly detection model is optimized using an artificial bee colony (ABC) algorithm;
updating, based on the monitoring, the experience function, wherein the experience function is updated based on a reward associated with the schedule adjustment action, wherein the reward is determined based on the monitoring;
after monitoring the execution, detecting an anomaly in the execution;
based on the anomaly, applying a scheduling adjustment on the plurality of tasks; and
updating the current state based on the anomaly.

20. The system of claim 19, the method further comprising:
prior to the monitoring:
initializing a population of potential anomaly detection solutions based on anomaly detection parameters;
performing a solution exploration on the population to obtain a new set of solutions;
calculating a fitness score for each solution of the new set of solutions and for each of the population;
selecting, from the new set of solutions, a candidate set of solutions based on the fitness score of each solution of the new set of solutions;
appending the candidate set of solutions to the population to obtain an updated population;
identifying, from the updated population, an optimal solution based on a fitness score of each of the updated population;
deploying the anomaly detection model using the optimal solution; and
after the deploying, updating the anomaly detection model using the ABC algorithm in response to detecting the anomaly.
